(19) United States
(12) Patent Application Publication
(10) Pub. No.: US 2015/0206261 A1
(43) Pub. Date: Jul. 23, 2015

(54) ONLINE INTERACTIVE BIDDING METHODS AND SYSTEMS

(71) Applicant: Mark William Humble, Nashville, TN (US)

(72) Inventor: Mark William Humble, Nashville, TN (US)

(21) Appl. No.: 14/162,451

(22) Filed: Jan. 23, 2014

(51) Int. Cl. G06Q 50/18; G06Q 30/08

(52) U.S. Cl. CPC G06Q 50/188; G06Q 30/08

(57) ABSTRACT

Online interactive bidding methods and systems used to sell products to consumers are disclosed. The methods and systems require a webpage that lists a product for sale and contains interactive webpage elements that permit a consumer to bid on the product and a computing device that receives product and bid information and immediately calculates counteroffers and displays the counteroffers and other optional information to the consumer. Through an iterative bid and counteroffer process, the consumer and product owner conclude a product purchase or terminate the bidding process.

### BACKGROUND OF THE INVENTION

1. Field of the Invention

The invention relates generally to methods and systems for bidding on products for sale and particularly to online interactive methods and systems for bidding on products for sale.

2. Description of Related Art

As the popularity of the internet increases, more and more consumers are using the internet to shop for and purchase products. In some situations, consumers are purchasing products using convenient and accessible auctions or online bidding methods and systems. For example, websites such as those owned by eBay, Inc. and TechMediaNetwork, Inc. display webpages that allow a consumer to place a bid on products listed for sale on the webpages, typically by selecting an interactive “Make offer” button, placing a bid number in an associated textbox, reviewing the offer, and submitting the bid by pressing a “Submit offer” button. The product owner then evaluates the bid and either accepts the bid or declines the bid and possibly makes a counteroffer. This process is useful but is hindered by the time it takes the product owner to recognize the bid, evaluate the bid, and make a counteroffer. Typically, it takes hours to days for the product owner to respond to the consumer's bids and the consumer to receive the response. To the chagrin of the parties, the consumer has often forgotten about the bid, lost interest in the product, or purchased another product instead of the product bid upon. As a result, the product owner often loses the sale because of the delay in processing and responding to the bid.

US20080288349 discloses methods and systems for facilitate online interactive communications. US20120185348 discloses systems and methods for implementing iterated sealed-bid auctions. US20120084171 discloses systems and methods for submitting a user-defined super bid that overrides an auction countdown. US20130297424 discloses methods for automating haggling before physical point-of-sale commerce. U.S. Pat. No. 8,364,544 discloses a comprehensive online bidding and sales management system for merchant processing services. US20130110652 discloses methods for negotiating product purchase using an electronic device. US20030111531 discloses methods and systems for interactively providing product related information on demand and providing personalized transactional benefits at a point of purchase.

Bidding methods and systems known in the art can be useful for selling products. However, they do not facilitate timely and efficient interactions between a consumer and the product owner engaged in a bidding process. There is, therefore, a need for online bidding methods and systems that significantly reduce the time required for the consumer and product owner to interact in a bidding process and either conclude or reject a product sale.

### SUMMARY OF THE INVENTION

It is, therefore, an object of the invention to provide online interactive bidding methods useful for selling products to consumers.

It is another object of the invention to provide online interactive bidding systems useful for selling products to consumers.

It is a further object of the invention to provide a means of communicating information about or instructions for using online interactive bidding methods and systems useful for selling products to consumers.

These and other objects of the invention are achieved through the use of methods and systems that display on a website a webpage containing a listing for a product for sale and one or more interactive webpage elements that permit a consumer viewing the webpage to bid on and purchase the product; and provide a computing device that interacts online via the internet with the webpage and receives from the webpage (1) information that identifies the product, (2) the bid placed by the consumer for the product, and (3) information that the consumer elected to purchase the product; wherein the computing device is associated with one or more database containing information about the product, and wherein the computing device is under the control of a software program that immediately (1) accesses the database and determines the identity of the product, (2) evaluates the bid from the consumer, (3) either accepts the bid or calculates a counteroffer, (4) displays on a webpage either a message that the bid was accepted or the counteroffer, (5) optionally, displays on a webpage one or more optional items of information from the database about the product, (6) when a counteroffer is made, displays a countdown timer showing the amount of time the consumer has to make a bid counteroffer, (7) when a counteroffer is made, displays an interactive webpage element that permits the consumer to make a bid counteroffer in response to the counteroffer and any optional items of information about the product from the database, and (8) when a counteroffer is made, displays an interactive webpage element that permits the consumer to accept any counteroffer from the computing device and elect to purchase the product.

Other and further objects, features, and advantages of the present invention will be readily apparent to those skilled in the art.

This summary is provided to introduce a selection of concepts in a simplified form that are further described below in the detailed description of the invention. This summary is not intended to identify key features or essential features of the claimed invention nor is it intended to be used to limit the scope of the claimed invention.

### DETAILED DESCRIPTION OF THE INVENTION

In one aspect, the invention provides online interactive bidding methods useful for selling products to consumers. The methods comprise displaying on a website a webpage containing a listing for a product for sale and one or more interactive webpage elements that permit a consumer viewing the webpage to bid on and purchase the product; and providing a computing device that interacts online via the internet with the webpage and receives from the webpage (1) information that identifies the product, (2) the bid placed by the consumer for the product, and (3) information that the consumer elected to purchase the product; wherein the computing device is associated with one or more database containing information about the product, and wherein the computing device is under the control of a software program that immediately (1) accesses the database and determines the identity of the product, (2) evaluates the bid from the consumer, (3) either accepts the bid or calculates a counteroffer, (4) displays on a webpage either a message that the bid was accepted or the counteroffer, (5) optionally, displays on a webpage one or more optional items of information from the database about the product, (6) when a counteroffer is made, displays a countdown timer showing the amount of time the consumer has to make a bid counteroffer, (7) when a counteroffer is made, displays an interactive webpage element that permits the consumer to make a bid counteroffer in response to the counteroffer and any optional items of information about the product from the database, and (8) when a counteroffer is made, displays an interactive webpage element that permits the consumer to accept any counteroffer from the computing device and elect to purchase the product.

Typically, the consumer and the computing device engage in an iterative process wherein the bid and counteroffer process is repeated one or more times. When a first counteroffer is made, the consumer enters a second bid. Then, the computing device makes one or more additional counteroffers and optionally displays one or more additional optional items of information in response to one or more bid counteroffers from the consumer. For example, if a consumer bids $10,000 on an automobile listed at a $12,000 asking price, the computing device counteroffer may be $11,500, which is displayed without, but preferably with, any optional additional information. A countdown timer giving the consumer 1 minute to make a bid counteroffer is displayed on the webpage. If the consumer makes a bid counteroffer of 10,500, the computing device immediately makes another counteroffer of $11,000 and displays an optional item of information from the database pointing out that the automobile has low mileage for its model year. A countdown timer giving the consumer 2 minutes to make a bid counteroffer is displayed on the webpage. The consumer makes a subsequent bid counteroffer and the computing device makes a subsequent counteroffer and displays an optional item of information from the database pointing out that the automobile comes with an inventive comprising 4 free oil changes for the automobile. This process is repeated as many times as allowed by the software program controlling the computing device, either alone based on an algorithm in the software program or using calculations based on bid factors in the database. In all instances, the webpage displays one or more interactive webpage elements that permits the consumer or the computing device to accept any offer (e.g., the asking price) or counteroffer, typically a clickable button or a touchable icon.

In preferred embodiments, the computing device also displays one or more interactive webpage elements that permit the consumer to review and conform the original bid, any bid counteroffers, and any purchase decision before submitting the information to the computing device.

All bids, counteroffers, purchase decisions, confirmations, and other information can be displayed using one or more interactive webpage elements on the initial webpage or on one or more other webpages or interactive webpage elements on such webpages.

In preferred embodiments, one or more optional items of information about the product retrieved from the database are displayed with each computing device counteroffer. Items of information include, but are not limited to, laudatory comments about the product, detailed information about the product, images of the product, incentives relating to the product, specifications for the product, videos about the product, and the like. Incentives include coupons or free items that accompany or are useful with the product, e.g., a percentage off the price or free maintenance associated with the product. In various embodiments, the information is a laudatory comment about the product that is designed to encourage the consumer to make a bid counteroffer to the latest counteroffer from the computing device, e.g., information highlighting the low mileage of an automobile, information highlighting the health benefits of a product, information about the inventory of a product, or information about low cost of or free shipping for a product. In certain embodiments, information includes images of the product that are designed to induce the consumer to purchase the product, e.g., an image that emphasized a positive attribute of the product or an image designed to be attractive to the consumer.

In certain embodiments, the optional items of information are displayed sequentially over time following a counteroffer. For example, a counteroffer is displayed along with an optional item of information and a timer counting down for two minutes, the time the consumer has to make a bid counteroffer. If the consumer has not placed a bid counteroffer within 1 minute after the timer starts, another item of information is displayed. Then, if the consumer has not placed a bid counteroffer within 1.5 minutes after the timer starts, another item of information is displayed. Then, another after 1.75 minutes, and the like.

The optional items of information displayed on the webpage along with counteroffers are displayed using any suitable methods for displaying information on a webpage. In various embodiments, the items of information are displayed aurally or visually, e.g., sound recordings, video recordings, visual text, popup windows (also known in the art as popup boxes) showing text, popup windows showing images, or popup windows showing videos. In one embodiment, the information is displayed as text and images in a web frame. In a preferred embodiment, the information is displayed as text in popup windows on the webpage.

The original bid, any counteroffers, any bid counteroffers, and the election to purchase can be binding or non-binding. In embodiments wherein the bids are binding, the webpage displays an accept button or similar webpage element for the consumer to accept the computing device's latest counteroffer. Similarly, when the consumer makes an offer or bid counteroffer, the computing device displays a message indicating that the bid or bid counteroffer has been accepted. In these embodiments, the computing device may subsequently display on the webpage instructions for completing the purchase, e.g., purchaser identity, payment methods, and shipping or local pickup terms. In embodiments wherein the bids are non-binding, the webpage generally displays instructions designed to encourage the consumer to go to a location where the consumer can view and/or test the product and typically interact with a salesperson that explains the attributes of the product and completes the sale.

The listing for a product for sale can be a simple written description of the product or an image of the product. In preferred embodiments, the webpage contains a listing for the product for sale comprising one or more of (1) a detailed written description of the product, e.g., specifications; (2) a price for the product; (3) an image or a video of the product; (4) contact and/or other information about the product seller; (5) terms and/or conditions relating to the bidding process; (6) one or more textboxes suitable for collecting information from the consumer, e.g., one or more of the consumer's name, address, phone number, age, gender, income, email address; (7) one or more textboxes or other elements that permit a consumer to submit question to the product owner concerning the product; and the like. In certain embodiments, such webpage contains a checkbox, toggle button, or similar webpage element that requires the consumer to indicate that the terms and/or conditions of the bidding process are acceptable to the consumer before the bidding process begins, i.e., before the consumer can place a first bid.

The interactive webpage elements useful in the invention are any webpage elements that facilitate and allow for completion of the bidding process. In preferred embodiments, the webpage elements are one or more webpage buttons that displays one or more textboxes suitable for receiving consumer input when the button is touched by the consumer or clicked by the consumer using a mouse pointer. The consumer inputs a numerical bid into the textbox and interacts with the webpage to send the bid to a remote computing device via the internet, e.g., by touching or clicking on a send or make offer button on the webpage. The interactive webpage element that permits the consumer to accept any counteroffer from the computing device is typically a button, e.g., an “Accept” or “Buy” button.

In one embodiment, the bid related interactive webpage elements are simply a textbox that only accepts numerical data (the bid), a “Submit” button that sends the bid to the computing device when “pressed” by the consumer, and an “Accept” button that sends the confirmation that the consumer purchased the product to the computing device when “pressed” by the consumer. After receiving the bid, the computing device immediately displays a numerical counteroffer, a countdown timer, and laudatory information about the product in one or more popup windows on a webpage being viewed by the consumer. The consumer can view the counteroffer and information and place a bid counteroffer using the webpage elements used to place the original offer. This process repeats until the consumer decides not to place another bid by allowing the countdown timer to expire, the consumer presses the Accept button, or the computing device terminates the process, e.g., because the bid is too low to warrant engaging the consumer in the process.

Computing devices useful in the invention are any computing devices capable of interacting with a database containing data, running a program capable of processing the data, and interacting with a website to receive data from and display data on a webpage. Such devices are well known to skilled artisans. Preferred computing devices include computers containing media that stores data and programs and containing electronic components that permit the computer to interact with websites via the internet, e.g., desktop personal computers, workstations, and laptops. Other computing devices include tablets, smartphones or other WAP-enabled devices, and similar devices that perform the same functions. In a preferred embodiment, the computing device is a desktop or laptop computer that contains a hard drive or other storage media that stores the program and the database and contains equipment and software that permits the computing device access the database and access the internet and websites on the internet, e.g., a modem and an internet browser such as Microsoft's internet explorer. Such devices and programs are known to skilled artisans.

The computing device typically runs a browser application and a database management system (DBMS). The browser application may be an HTTP client such as Microsoft Internet Explorer, Mozilla Firefox, Google Chrome, Apple Safari, and the like. The browser may also include a WAP-enabled browser in the case of a cell phone, PDA or other wireless device allowing a user of the computing device to access, process and view information and webpages available to it from the internet. The DMBS may be SQL, ODBC, JDB, and the like.

The computing device can run any suitable operating system, e.g., Microsoft Windows, Windows Phone, Android, iOS, Linux, OS X, IBM z/OS, and the like.

The computing devices are associated with or coupled to one or more databases containing information about the product. The association permits computing devices under the control of one or more software programs to access data in the database, via a database management system, and perform calculations or other actions on or using the data based upon instructions from the software programs, e.g., display the data on a computer monitor or on a webpage or calculate counteroffers using the information in the database. The database can be any suitable database application, e.g., Microsoft Access, Oracle, and the like.

Information in the database about the product useful in the invention is any qualitative or quantitative data that facilitates the online interactive bidding methods and systems of the invention. Typical information includes an asking price, one or more laudatory comments about the product, one or more messages or images indicating that a bid was accepted, one or more images of the product, a minimum acceptable price, one or more bid factors used by the software program to calculate the number of counteroffers and the numerical value for counteroffers. Usually, the data is text and numbers associates with bidding and making counteroffers, e.g., numerical bids and laudatory comments about the product. Such information also includes images that convey information about the product.

In some embodiments, the database contains one or more bid factors that are used to determine if the bid made is considered a bid worth considering and making a counteroffer. The software program evaluates the bid using these factors and (1) proceeds using the methods described herein if the bid is worth considering or (2) displays a message to the consumer on the webpage that the bid was not considered and invites the consumer to submit another bid. The message is displayed using any suitable method, e.g., a popup message or a message highlighted in an element on the webpage, e.g., frame. If an acceptable bid is not received within the allotted time, the computing device terminates the bidding process, makes another counteroffer, or makes a final offer. To illustrate, the database could contain bid factors that instruct the software program to discount the asking price by 10% in the first counteroffer, by an additional 5% in the second counteroffer, and by an additional 3% in the third counteroffer, by an additional 0% in the fourth counteroffer but display an offer for free maintenance, by an additional 0% in the fifth counteroffer but display one or more laudatory comments about the product, and by an additional 0% in the sixth counteroffer but terminating the process and inviting the consumer to contact the product owner either remotely or in person. Many such schemes are available to facilitate the method of the invention.

In some embodiments, the one or more optional items of information displayed on a webpage from the database is a listing of one or more different products that are priced at or about the consumer's latest bid or bid counteroffer. Typically, the items of information are displayed when the consumer's bid or bid counteroffer is lower than the minimum amount acceptable for the product and it is desirable to offer alternative products that would appear to be affordable to the consumer based on the consumer's latest bid or bid counteroffer. For example, if an automobile originally offered at $12,000 has a lowest allowable sale price of $11,000 but a consumer makes an offer of only $10,000, the optional items of information displayed on a webpage from the database could be one or more other automobiles that are offered at about a price of $10,000. If the consumer selects one of these automobiles, the online interactive bidding methods of the invention begin for the selected automobile or alternative automobiles in inventory or from other sources may be displayed, even if these alternative products are not available for bidding. In these embodiments, the different products can be displayed at the same time or can be displayed sequentially, typically from highest price to lowest price.

The software program that controls the computing device comprises computer-executable instructions, such as program modules, that are executed by the computing device. Generally, program or program modules include routines, program commands, objects, components, data structures, and the like that perform particular tasks or implement particular procedures, e.g., perform calculations, store and retrieve data from associated databases, and manage communications between computers and websites via the internet. The software program is written in any programming language that permits the computing device to accomplish the methods of the invention. Typical languages include HyperText Markup Language, Java, Javascript, PHP, Python, ASP.NET, and the like. Developing software programs to enable the methods and systems of the invention is within the scope of skilled artisans, e.g., software engineers.

The term “immediately” means that, absent problems with the internet or absent problems with the computing devices and databases utilizing the methods, the consumer receives a counteroffer and related information within about 5 minutes or less from the time the bid is communicated to the computing device, preferably about 2 minutes or less, more preferably about 1 minute or less, most preferably 30 seconds or less. In preferred embodiments, the consumer receives a counteroffer and related information within about 10 seconds or less, preferably about 5 seconds or less, more preferably about 2 seconds or less, and most preferably about 1 second or less. This means that the computing device receives the bid, identifies the product from the database, evaluates the bid, calculates the counteroffer, displays the counteroffer and any other optional information is about 10 seconds or less, preferably about 5 seconds or less, more preferably about 2 seconds or less, and most preferably about 1 second or less.

In various embodiments, this process takes about 0.5 seconds or less, preferably about 0.1 seconds or less.

The webpage can be displayed to the consumer on any suitable device capable of showing webpages, preferably on a computer monitor, laptop screen, tablet screen, or smartphone screen.

In another aspect, the invention provides online interactive bidding systems useful for selling products to consumers. The systems comprise a website displaying a webpage containing a listing for a product for sale and one or more interactive webpage elements that permit a consumer viewing the webpage to bid on and purchase the product; and computing device that interacts online via the internet with the webpage and receives from the webpage (1) information that identifies the product, (2) the bid placed by the consumer for the product, and (3) information that the consumer elected to purchase the product; wherein the computing device is associated with one or more database containing information about the product, and wherein the computing device is under the control of a software program that immediately (1) accesses the database and determines the identity of the product, (2) evaluates the bid from the consumer, (3) either accepts the bid or calculates a counteroffer, (4) displays on a webpage either a message that the bid was accepted or the counteroffer, (5) optionally, displays on a webpage one or more optional items of information from the database about the product, (6) when a counteroffer is made, displays a countdown timer showing the amount of time the consumer has to make a bid counteroffer, (7) when a counteroffer is made, displays an interactive webpage element that permits the consumer to make a bid counteroffer in response to the counteroffer and any optional items of information about the product from the database, and (8) when a counteroffer is made, displays an interactive webpage element that permits the consumer to accept any counteroffer from the computing device and elect to purchase the product.

Unlike other online bidding methods and systems currently available, the methods and systems of the present invention provide an interactive response that provides immediate feedback to the consumer in response to the consumer's bid on a product.

Methods and systems for hosting websites and displaying webpages that display product listings and interact with remote computing devices such as computers, tablets, smartphones, and similar devices via the internet are known to skilled artisans. Similarly, webpage elements such as buttons, option buttons, toggle buttons, popup windows, checkboxes, labels, images, icons, textboxes, countdown timers (e.g., countdown clocks or countdown widgets or countdown gadgets), web frames, and similar webpage elements that permit webpages to remotely interact with computing devices are known to skilled artisans. Typical such elements comprise buttons that are activated by a click using a mouse or a touch with a finger or stylus and a popup window comprising one or more textboxes that receive numerical or textural input from the user, e.g., numerical input in the form of a bid on a product. In some embodiments, additional information about the product is displayed in one or more webpage web frames that contain stationary information or non-stationary information, e.g., a rotating image of the product. One or more of the popup windows used in the invention can be modal, non-modal, or a combination thereof as needed for a particular function in the bidding methods described herein.

The methods and systems of the invention are described and exemplified in terms defined in the context of using the internet to display webpages on websites. These methods and systems are also defined to include other related methods and systems that accomplish the same function. For example, the invention is defined to include methods and systems wherein one or more computing devices are connected directly via wired or wireless connections. As another example, the invention is defined to include methods and systems wherein web services or application services share logic, data, and processes through a programmatic interface across a network, but do not provide the consumer with a graphical user interface (GUI). When using such web services, the applications interface with each other but do not interface with the consumer. Then, application developers add the web service to a GUI such as a web page or an executable program to offer specific functionality to the consumer. Such web services allow different applications from different sources to communicate with each other without time-consuming custom coding. Because all communication is in XML, web services are not tied to any one operating system or programming language. For example, Java can talk with Perl, Windows applications can talk with UNIX applications, and the like. These and other similar methods and systems are known to skilled artisans.

In another aspect, the present invention provides a means for communicating information about or instructions for using online interactive bidding methods and systems useful for selling products to consumers. The communicating means comprises a document, digital storage media, optical storage media, audio presentation, or visual display containing the information or instructions. Preferably, the communication is a webpage, webpage element, brochure, product label, advertisement, or visual display containing such information or instructions. More preferably, the communication is a displayed webpage or a popup window or web frame on a displayed webpage. Useful information includes one or more of (1) information about online interactive bidding methods and systems, (2) the benefits and advantages of using online interactive bidding methods and systems for purchasing products, and (3) contact information for consumers to use if they have a question about online interactive bidding methods and systems. In some embodiments, the means is specifically designed to inform and educate consumers about the immediate and efficient nature of the present methods and systems and thus overcome consumer's reluctance to participate in current bidding processes that often take hours or days to conclude. Useful instructions include (1) methods and techniques for using online interactive bidding methods and systems to purchase a product, (2) methods for completing a product purchase, and (3) methods for obtaining a purchased product, e.g., shipping of picking up a product.

The communication means is useful for instructing consumers on the methods for using the present invention and communicating about the benefits of online interactive bidding methods and systems for consumers.

The various techniques described herein may be implemented in connection with hardware, software or, where appropriate, a combination of both. Thus, the methods and systems of the invention, or certain aspects or portions thereof, may take the form of program code (i.e., instructions) or databases embodied in tangible media, such as floppy diskettes, CD-ROMs, hard drives, or any other machine-readable storage medium where, when the program code is loaded into and executed by a computing device, such as a computer, the computing device becomes an apparatus for practicing the present invention.

Although various embodiments of the invention may use various aspects of the invention in the context of one or more stand-alone computing devices or systems, the invention is not so limited, but rather may be implemented in connection with any computing environment, such as a network or distributed computing environment. Still further, aspects of the present invention may be implemented in or across a plurality of processing chips or devices, and storage may similarly be affected across a plurality of devices, e.g., personal computers, network servers, and handheld devices.

As used herein, the singular form of a word includes the plural, and vice versa, unless the context clearly dictates otherwise. Thus, the references “a”, “an”, and “the” are generally inclusive of the plurals of the respective terms. For example, reference to “a method” includes a plurality of such “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

Unless defined otherwise, all technical and scientific terms, terms of art, and acronyms used herein have the meanings commonly understood by one of ordinary skill in the art in the field(s) of the invention, or in the field(s) where the term is used. Although any, methods, systems, or other means or materials similar or equivalent to those described herein can be used in the practice of the present invention, the preferred methods, systems, or other means or materials are described herein.

In the specification, there have been disclosed typical preferred embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. An online interactive bidding method comprising displaying on a website a webpage containing a listing for a product for sale and one or more interactive webpage elements that permit a consumer viewing the webpage to bid on and purchase the product; and providing a computing device that interacts online via the internet with the webpage and receives from the webpage (1) information that identifies the product, (2) the bid placed by the consumer for the product, and (3) information that the consumer elected to purchase the product; wherein the computing device is associated with one or more database containing information about the product, and wherein the computing device is under the control of a software program that immediately (1) accesses the database and determines the identity of the product, (2) evaluates the bid from the consumer, (3) either accepts the bid or calculates a counteroffer, (4) displays on a webpage either a message that the bid was accepted or the counteroffer, (5) optionally, displays on a webpage one or more optional items of information from the database about the product, (6) when a counteroffer is made, displays a countdown timer showing the amount of time the consumer has to make a bid counteroffer, (7) when a counteroffer is made, displays an interactive webpage element that permits the consumer to make a bid counteroffer in response to the counteroffer and any optional items of information about the product from the database, and (8) when a counteroffer is made, displays an interactive webpage element that permits the consumer to accept any counteroffer from the computing device and elect to purchase the product.

2. The method of claim 1 wherein bid and counteroffer process is repeated one or more times.

3. The method of claim 1 wherein the consumer receives a counteroffer and related information within about 5 minutes or less from the time the bid is communicated to the computing device.

4. The method of claim 1 further comprising one or more interactive webpage elements that permit the consumer to review and conform the original bid, any bid counteroffers, and any purchase decision before submitting the information to the computing device

5. The method of claim 1 wherein one or more optional items of information about the product is disclosed along with each computing device counteroffer.

6. The method of claim 5 wherein the item of information is one or more of laudatory comments about the product, detailed information about the product, images of the product, incentives relating to the product, specifications for the product, and videos about the product.

7. The method of claim 1 wherein the listing for the product is a written description of the product.

8. The method of claim 7 wherein the listing for the product further comprises one or more of (1) a detailed written description of the product, (2) a price for the product, (3) a image or a video of the product, (4) contact or other information about the product seller, (5) terms or conditions relating to the bidding process, (6) one or more textboxes suitable for collecting information from the consumer; and (7) one or more textboxes or other elements that permit a consumer to submit question to the product owner concerning the product.

9. The method of claim 1 wherein the original bid and any counteroffers and bid counteroffers are binding.

10. The method of claim 1 wherein the original bid and any counteroffers and bid counteroffers are non-binding.

11. The method of claim 1 wherein webpage elements are buttons, option buttons, toggle buttons, popup windows, checkboxes, labels, images, icons, textboxes, countdown timers, and web frames.

12. The method of claim 1 wherein webpage elements are buttons, textboxes, and popup windows.

13. The method of claim 12 wherein the popup windows are modal, non-modal, or a combination thereof.

14. The method of claim 1 wherein the computing device is a computer, tablet, or smartphone.

15. The method of claim 1 wherein the computing device is a computer.

16. The method of claim 1 wherein database contains information about an asking price, one or more laudatory comments about the product, one or more messages or images indicating that a bid was accepted, one or more images of the product, a minimum acceptable price, one or more bid factors used by the software program to calculate the number of counteroffers and the numerical value for counteroffers.

17. An online interactive bidding system comprising a website displaying a webpage containing a listing for a product for sale and one or more interactive webpage elements that permit a consumer viewing the webpage to bid on and purchase the product; and computing device that interacts online via the internet with the webpage and receives from the webpage (1) information that identifies the product, (2) the bid placed by the consumer for the product, and (3) information that the consumer elected to purchase the product; wherein the computing device is associated with one or more database containing information about the product, and wherein the computing device is under the control of a software program that immediately (1) accesses the database and determines the identity of the product, (2) evaluates the bid from the consumer, (3) either accepts the bid or calculates a counteroffer, (4) displays on a webpage either a message that the bid was accepted or the counteroffer, (5) optionally, displays on a webpage one or more optional items of information from the database about the product, (6) when a counteroffer is made, displays a countdown timer showing the amount of time the consumer has to make a bid counteroffer, (7) when a counteroffer is made, displays an interactive webpage element that permits the consumer to make a bid counteroffer in response to the counteroffer and any optional items of information about the product from the database, and (8) when a counteroffer is made, displays an interactive webpage element that permits the consumer to accept any counteroffer from the computing device and elect to purchase the product.

18. A means for communicating information about or instructions for using online interactive bidding methods and systems useful for selling products to consumers comprising a document, digital storage media, optical storage media, audio presentation, or visual display containing the information or instructions.

19. The means of claim 18 wherein the means is selected from the group consisting of a webpage, webpage element, brochure, product label, advertisement, or visual display containing such information or instructions.

20. The means of claim 18 wherein the means is selected from the group consisting of a displayed webpage, a popup window, and web frame on a displayed webpage.
